(19) United States
(12) Patent Application Publication
(10) Pub. No.: US 2024/0185239 A1
(43) Pub. Date: Jun. 6, 2024

(54) SERVER AND PLATFORM FOR VERIFYING BLOCKCHAIN-RELATED RELIABILITY IN INTEGRATIVE MANNER AND OPERATING METHOD OF THE SAME

(71) Applicant: AhnLab Blockchain Company, Inc., Seongnam-si (KR)

(72) Inventors: Jong Seok KANG, Seongnam-si (KR); Ju Young LIM, Seongnam-si (KR); Ji Hwang YI, Seongnam-si (KR)

(21) Appl. No.: 18/526,576

(22) Filed: Dec. 1, 2023

(30) Foreign Application Priority Data
Dec. 2, 2022 (KR) 10-2022-0166629

(51) Int. Cl. G06Q 20/40; G06Q 20/38

(52) U.S. Cl. CPC G06Q 20/401; G06Q 20/389

(57) ABSTRACT

Provided are a server for verifying reliability of a target that is a potentially dangerous element when a blockchain is used, an integrated blockchain-related reliability verification platform, and an operating method of the server. The server includes a processor configured to verify reliability of at least one of a cryptocurrency, a blockchain network, and a decentralized application (DApp). The processor includes a collection module configured to collect information required for verifying reliability of the cryptocurrency, the blockchain network, and the DApp, an analysis module configured to analyze and evaluate the collected information and then output a reliability value of a reliability verification target as an evaluation result, and a verification module configured to verify reliability of the reliability verification target on the basis of the reliability value.

### CROSS-REFERENCE TO RELATED APPLICATION

This application claims priority to and the benefit of Korean Patent Application No. 10-2022-0166629, filed on Dec. 2, 2022, the disclosure of which is incorporated herein by reference in its entirety.

### BACKGROUND

### 1. Field of the Invention

The present invention relates to integrated blockchain-related reliability verification, and more particularly, to a server for verifying reliability (or safety) of a blockchain-based cryptocurrency, a blockchain network, and a decentralized application (DApp) in an integrative manner, an operating method of the same, and a platform including the same.

### 2. Discussion of Related Art

Cryptocurrencies represented by Bitcoin are being traded on the basis of blockchain technology. Each deal is packaged in the form of a transaction and stored in blocks of a blockchain. Since the blockchain is copied and stored in blockchain nodes, it is very difficult to manipulate information on a specific person's transaction. Accordingly, the blockchain-based cryptocurrency transaction method is recognized as highly reliable.

However, despite the reliability, accidents, such as security accidents caused by hacking, money transfers for concealing crimes, and the like, occur due to limitations of security technology of exchanges. Since virtual assets are moved through such abnormal transactions, not only do their origins become unclear, but ultimately, the owners of the virtual assets are directly harmed by the withdrawal of the virtual assets.

In this way, currently, fraud accidents, such as hacking and phishing, occur frequently in relation to cryptocurrencies.

Also, due to the lack of blockchain-related information, such as a cryptocurrency, a blockchain network, a decentralized application (DApp), and the like, a fraud case or a risk of approach to a dangerous cryptocurrency or network or the like may exist.

A user may connect his or her electronic wallet to a DApp without major limitations, and thus fraud accidents, such as hacking, phishing, and the like, may be caused by the DApp.

Therefore, a technology for verifying reliability (or safety) of cryptocurrencies, blockchain networks, DApps, and the like is currently necessary for a user to use the cryptocurrencies, the blockchain networks, the DApps, and the like.

The background art is technical information that the applicant had when devising the present invention or that the applicant acquired in the process of devising the present invention, and cannot necessarily be referred to as technology that was well known to the public before the filing of the application for the present invention.

### SUMMARY OF THE INVENTION

The present invention is directed to providing an integrated blockchain-related reliability verification server for verifying reliability of dangerous elements that may exist when a blockchain is used, to help a user to safely use a service such as a blockchain-based cryptocurrency transaction.

The present invention is also directed to providing an integrated blockchain-related reliability verification server for not only verifying reliability (or safety) of a cryptocurrency (or a token) by monitoring (collecting and analyzing) information related to reliability of the cryptocurrency among transaction information provided by a network or exchange related to the cryptocurrency but also verifying the reliability by collecting information related to an individual or group that develops or runs the cryptocurrency.

The present invention is also directed to providing an integrated blockchain-related reliability verification server for verifying reliability in relation to a blockchain network related to a cryptocurrency by monitoring information related to validity of a network address, whether the network is actually run, and a network management community.

The present invention is also directed to providing an integrated blockchain-related reliability verification server for verifying reliability of a decentralized application (DApp), which is a blockchain-based application, by providing a notification of a request that may be dangerous (e.g., a request for too many permissions) among requests that may be made by the DApp and monitoring information related to the reliability of the DApp and information related to an individual or group that develops or manages the DApp.

The present invention is also directed to providing an operating method of an integrated blockchain-related reliability verification server.

The present invention is also directed to providing a platform including an integrated blockchain-related reliability verification server.

Objectives of the present invention are not limited to those described above, and other objectives of the present invention may also be clearly understood by those with ordinary knowledge in the technical field to which the present invention pertains from the following description.

According to an aspect of the present invention, there is provided a server for verifying reliability of a target that is a potentially dangerous element when a blockchain is used.

The server includes a processor configured to verify reliability of at least one of a cryptocurrency, a blockchain network, and a DApp.

The processor includes a collection module configured to collect information required for verifying reliability of the cryptocurrency, the blockchain network, and the DApp, an analysis module configured to analyze and evaluate the collected information and then output a reliability value of a reliability verification target as an evaluation result, and a verification module configured to verify reliability of the reliability verification target on the basis of the reliability value.

The processor may further verify reliability of at least one of a cryptocurrency-related company, a blockchain network management company, and a DApp-related company.

The processor may further include a notification message transmission module configured to provide a verification result of the reliability verification target to an interoperating user terminal.

The collection module may collect information related to the reliability of the cryptocurrency among transaction information of the blockchain network and collect information related to the reliability of the cryptocurrency among transaction information provided by a cryptocurrency exchange.

The collection module may collect information related to validity of a blockchain network address and information related to whether the blockchain network is actually run.

The collection module may collect detailed information on the DApp, and the detailed information may include information requested for use of the DApp by the DApp.

The analysis module may analyze the detailed information and generate a report document including corresponding content when the DApp in use requests many permissions.

The processor may further include a notification message transmission module configured to provide a verification result of the reliability verification target and content included in the report document to an interoperating user terminal.

The analysis module may comparatively analyze information collected for verifying the reliability of the reliability verification target with reliability evaluation criterion information prestored in relation to the reliability verification target.

The verification module may verify the reliability of the reliability verification target by comparing a reliability verification criterion value prestored in relation to the reliability verification target with the reliability value.

According to another aspect of the present invention, there is provided an operating method of a server for verifying reliability of a target that is a potentially dangerous element when a blockchain is used, the operating method including collecting information required for verifying reliability of a cryptocurrency, a blockchain network, and a DApp, analyzing and evaluating the collected information and then outputting a reliability value of a reliability verification target as an evaluation result, and verifying reliability of the reliability verification target on the basis of the reliability value.

The operating method may further include verifying reliability of at least one of a cryptocurrency-related company, a blockchain network management company, and a DApp-related company.

The operating method may further include providing a verification result of the reliability verification target to an interoperating user terminal.

The collecting of the information may include collecting information related to the reliability of the cryptocurrency among transaction information of the blockchain network and collecting information related to the reliability of the cryptocurrency among transaction information provided by a cryptocurrency exchange.

The collecting of the information may include collecting information related to validity of a blockchain network address and information related to whether the blockchain network is actually run.

The collecting of the information may include collecting detailed information on the DApp, and the detailed information may include information requested for use of the DApp by the DApp.

The analyzing of the collected information may include analyzing the detailed information and generating a report document including corresponding content when the DApp in use requests many permissions.

The operating method may further include providing a verification result of the reliability verification target and content included in the report document to an interoperating user terminal.

The analyzing of the collected information may include comparatively analyzing information collected for verifying reliability of the reliability verification target with reliability evaluation criterion information prestored in relation to the reliability verification target.

The verifying of the reliability may include verifying reliability of the reliability verification target by comparing the reliability value with a reliability verification criterion value prestored in relation to the reliability verification target.

Details of various embodiments of the present invention other than the solutions described above are included in the following description and drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a platform including an integrated blockchain-related reliability verification server according to an exemplary embodiment of the present invention;

FIG. 2 is a block diagram of an integrated reliability verification server (100) according to an exemplary embodiment of the present invention; and

FIG. 3 is a flowchart illustrating operations of an integrated blockchain-based reliability verification server according to an exemplary embodiment of the present invention.

### DETAILED DESCRIPTION OF EXEMPLARY EMBODIMENTS

Advantages and features of the present invention and methods of achieving the same will become apparent with reference to exemplary embodiments that are described in detail in conjunction with the accompanying drawings. However, the present invention is not limited to the exemplary embodiments set forth herein and can be implemented in various different forms. The exemplary embodiments are provided only to make the disclosure of the present invention complete and fully convey the scope of the present invention to those with ordinary knowledge in the technical field of the present invention. The present invention is defined only by the category of the claims.

Shapes, sizes, ratios, angles, numbers, and the like shown in the drawings for describing the exemplary embodiments of the present invention are illustrative, and the present invention is not limited thereto. Throughout the specification, the same reference numeral refers to the same component. When it is determined that a detailed description of associated known technology unnecessarily obscures the subject matter of the present invention, the detailed description will be omitted from the description of the present invention. As used herein, the terms “comprise,” “include,” “have,” and the like do not preclude the presence or addition of other components unless used along with the term “only.” The singular forms include the plural forms as well unless the context clearly indicates otherwise.

Components are interpreted as including an error range even when there is no explicit description thereof.

When a temporal relationship between operations is described, for example, when a time sequence of operations is described using “after,” “subsequently,” “next,” or “before,” there may be an intervening operation between the operations unless the term “immediately” or “directly” is used.

Although terms including “first,” “second,” and the like may be used for describing various components, the components are not limited by the terms. These terms are merely used for distinguishing one component from another. Therefore, in the following description, a first component may be a second component within the technical spirit of the present invention.

In describing components of the present invention, terms such as “first,” “second,” “A,” “B,” “(a),” “(b),” and the like may be used. These terms are only used to distinguish the components from other components, and the essence, order, or number of the components is not limited by the terms. When a first component is described as being “connected,” “coupled,” or “joined” to a second component, the first component may not only be directly connected or coupled to the second component but may also be indirectly connected to the second component, or a third component may be “interposed” between the first and second components unless explicitly described otherwise.

The term “at least one” is to be understood as including all combinations of one or more related components. For example, “at least one of a first component, a second component, and a third component” may mean not only the first component, the second component, or the third component but also combinations of two or more thereof.

Features of several embodiments of the specification can be joined or combined together in part or as a whole and technically implemented together in various ways. Embodiments may be implemented independent of each other or implemented together in conjunction with each other.

The present invention will be described below with reference to the accompanying drawings and exemplary embodiments. Components shown in the drawings have a different scale from actual components for convenience of description and thus are not limited to the scale shown in the drawings.

Hereinafter, an integrated blockchain-related reliability verification server, an operating method of the same, and a platform including the same according to exemplary embodiments of the present invention will be described with reference to the accompanying drawings.

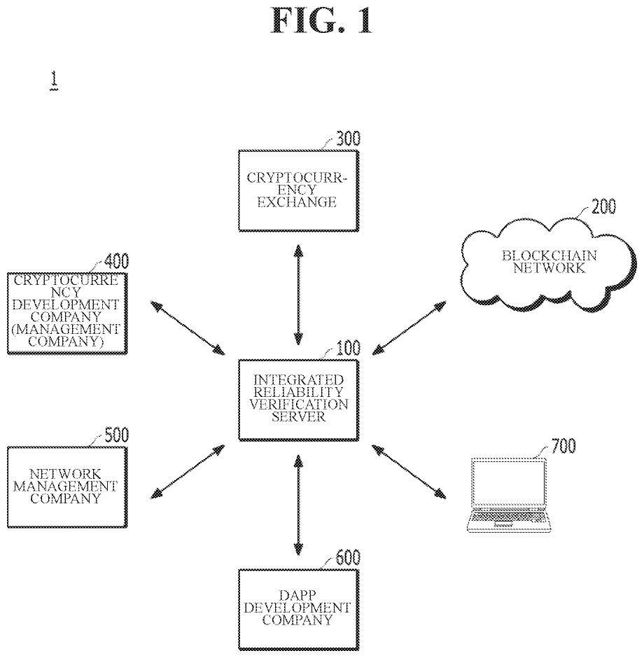

FIG. 1 is a diagram illustrating a platform including an integrated blockchain-related reliability verification server according to an exemplary embodiment of the present invention.

An integrated blockchain-related reliability verification platform 1 according to the exemplary embodiment of the present invention includes a server 100 for verifying blockchain-related reliability in an integrative manner.

The integrated reliability verification server 100 according to the exemplary embodiment may verify a dangerous element that may exist when a blockchain is used, to help a user to safely use a service such as a blockchain-based cryptocurrency transaction and the like.

According to an exemplary embodiment, the integrated reliability verification server 100 may collect and analyze information related to the reliability of a cryptocurrency among transaction information provided by at least one of a blockchain network 200 and a cryptocurrency exchange 300, thereby verifying safety.

Also, the integrated reliability verification server 100 may collect information on a company (a development company or a management company) 400 that runs cryptocurrency-related business, thereby verifying reliability of the company 400.

According to an exemplary embodiment, the integrated reliability verification server 100 may determine whether a blockchain network address is valid and whether the blockchain network is actually run and verify reliability by collecting and analyzing information on a blockchain network management company (or community) 500.

According to an exemplary embodiment, the integrated reliability verification server 100 may analyze decentralized application (DApp)-related information and provide a notification of a request that may be dangerous among requests that are made for use of the DApp.

For example, when a request made to use a DApp involves many permissions, the integrated reliability verification server 100 may provide a notification of the request.

The integrated reliability verification server 100 may collect and analyze information related to reliability of the DApp, thereby verifying the reliability.

Also, the integrated reliability verification server 100 may collect information on a company (a development company or a management company) 600 that runs DApp-related business, thereby verifying reliability of the company 600.

The integrated reliability verification server 100 according to the exemplary embodiment may provide a notification of a verification result to an interoperating user terminal 700.

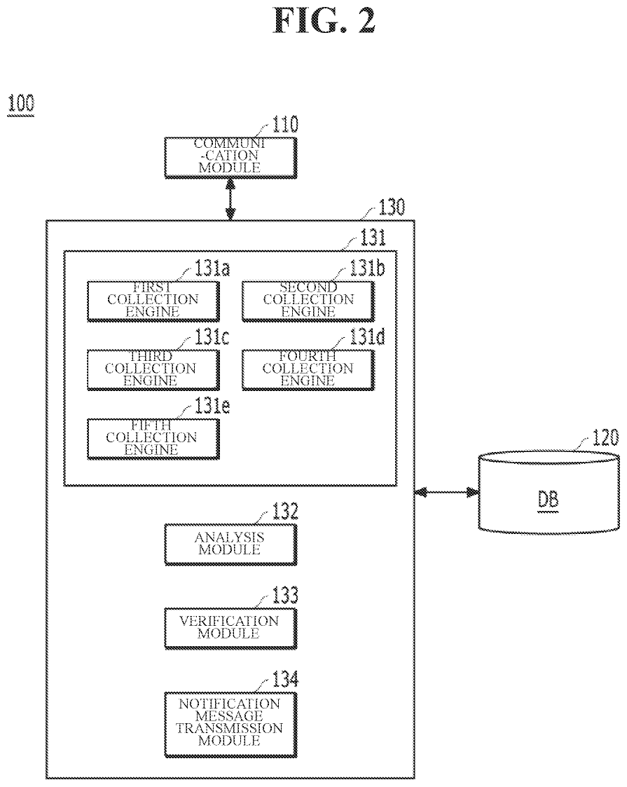

FIG. 2 is a block diagram of the integrated reliability verification server 100 according to an exemplary embodiment of the present invention.

Referring to FIGS. 1 and 2, the integrated reliability verification server 100 according to the exemplary embodiment may include at least one communication module 110, at least one database (DB) 120, and at least one processor 130. The configuration of the integrated reliability verification server 100 is not limited hereto.

The communication module 110 is provided for communication with the blockchain network, an external server, and the like and may include one communication port or multiple communication ports depending on implementation of the integrated reliability verification server 100.

The DB 120 may store information acquired or processed according to operations of the integrated reliability verification server 100 and information required for operations of the integrated reliability verification server 100.

The processor 130 performs overall functions of the integrated reliability verification server 100 and may include multiple function modules (or function engines).

The multiple function modules may be implemented in one processor in an integrative manner or separately implemented in different processors. In the present embodiment, an example in which the multiple function modules are implemented in one processor 130 in an integrative manner will be described.

According to an exemplary embodiment, the multiple function modules provided in the integrated reliability verification server 100 may include a collection module 131, an analysis module (or evaluation module) 132, a verification module 133, and a notification message transmission module 134, but the types of function modules are not limited thereto.

The collection module 131 according to the exemplary embodiment is configured to collect various types of information, and information collected by the collection module 131 may be stored in the DB 120.

The collection module 131 may collect transaction information of the blockchain network 200 in conjunction with the blockchain network 200.

For example, the collection module 131 may collect all transaction information of the blockchain network 200 and collect preset information, for example, information related to the reliability of a cryptocurrency, among the transaction information.

According to an exemplary embodiment, transaction information of the blockchain network 200 may be collected by a first collection engine (or network transaction information collection engine) 131a of the collection module 131.

The collection module 131 may collect cryptocurrency-related transaction information in conjunction with a server (exchange server) 310 provided in the cryptocurrency exchange 300.

For example, the collection module 131 may collect all transaction information provided by the exchange server 310 or collect preset information, for example, information related to reliability of the cryptocurrency, among the transaction information.

According to an exemplary embodiment, transaction information may be collected from the exchange server 310 by a second collection engine (or exchange transaction information collection engine) 131b of the collection module 131.

The collection module 131 may collect information on the company 400 in conjunction with a server (cryptocurrency-related company server) 410 provided in the company (the development company or the management company) 400 that runs the cryptocurrency-related business, or collect information on the company 400 that is made available to the public.

According to an exemplary embodiment, information on the cryptocurrency-related company (including the development company and the management company) may be collected by a third collection engine (or related company information collection engine) 131c of the collection module 131.

The collection module 131 may collect information for verifying the reliability of the blockchain network, for example, information related to validity of a blockchain network address, information related to whether the blockchain network is actually run, information on the blockchain network management company, and the like.

For example, the collection module 131 may collect information of the blockchain network management company 500 in conjunction with a server (blockchain network management company server) provided in the blockchain network management company 500 and collect information on the management company 500 that is made available to the public.

According to an exemplary embodiment, information for verifying reliability of the blockchain network may be collected by a fourth collection engine (or blockchain verification information collection engine) 131d of the collection module 131.

The collection module 131 may collect information for verifying the DApp and the DApp-related company (company related to development and management of the DApp) 600.

According to an exemplary embodiment, the collection module 131 may collect detailed information on the DApp, for example, information required for using the DApp.

For example, the collection module 131 may collect detailed information on the DApp in conjunction with a server (DApp-related company server) 610 provided in the DApp-related company 600 or collect DApp-related detailed information that is made available to the public.

According to an exemplary embodiment, the collection module 131 may collect information for verifying reliability of the DApp, for example, in conjunction with the DApp-related company server 610.

According to an exemplary embodiment, the collection module 131 may collect information on the DApp-related company 600 in conjunction with the DApp-related company server 610 and collect information on the DApp-related company 600 that is made available to the public.

According to an exemplary embodiment, DApp-related information and information on the DApp-related company 600 may be collected by a fifth collection engine (or DApp and related company verification information collection engine) 131e of the collection module 131.

The analysis module 132 according to the exemplary embodiment of the present invention may analyze and evaluate information which is collected by the collection module 131 and stored in the DB 120 according to a setting made in advance and provide the evaluation result as a value, and the value may be stored in the DB 120.

According to an exemplary embodiment, the analysis module 132 may analyze and evaluate information related to the reliability of the cryptocurrency among information collected (or stored in the DB) by the collection module 131 and quantify the evaluation result.

For example, the analysis module 132 may evaluate the information related to the reliability of the cryptocurrency and give a high value when the reliability is high, or give a low value when the reliability is low.

For example, evaluation criterion values related to cryptocurrency reliability may be set to 1 to 10, and the analysis module 132 may quantify a reliability evaluation result as one of 1 to 10. Here, the quantification method is not limited thereto.

To this end, the analysis module 132 or the integrated reliability verification server 100 may store criterion information for evaluating the reliability of a cryptocurrency, and the analysis module 132 may comparatively analyze the collected information related to the reliability of the cryptocurrency with the prestored criterion information for evaluating the reliability of a cryptocurrency.

According to an exemplary embodiment, the analysis module 132 may analyze and evaluate information on a cryptocurrency-related company (including the developing company and the management company) among the information collected by the collection module 131 and quantify the evaluation result.

For example, the analysis module 132 may evaluate the information on the cryptocurrency-related company and give a high value when the reliability is high, or give a low value when the reliability is low.

For example, evaluation criterion values related to reliability of a cryptocurrency-related company may be set to 1 to 10, and the analysis module 132 may quantify a reliability evaluation result as one of 1 to 10. Here, the quantification method is not limited thereto.

To this end, the analysis module 132 or the integrated reliability verification server 100 may store criterion information for evaluating the reliability of a cryptocurrency-related company, and the analysis module 132 may comparatively analyze the collected information on the cryptocurrency-related company with the prestored criterion information for evaluating the reliability of a cryptocurrency-related company.

According to an exemplary embodiment, the analysis module 132 may analyze and evaluate information related to the reliability of the blockchain network among the information collected by the collection module 131 and quantify the evaluation result.

For example, the analysis module 132 may evaluate the information related to the reliability of the blockchain network and give a high value when the reliability is high, or give a low value when the reliability is low.

For example, evaluation criterion values related to reliability of a blockchain network may be set to 1 to 10, and the analysis module 132 may quantify a reliability evaluation result as one of 1 to 10. Here, the quantification method is not limited thereto.

To this end, the analysis module 132 or the integrated reliability verification server 100 may store criterion information for evaluating the reliability of a blockchain network, and the analysis module 132 may comparatively analyze the collected information on the blockchain network with the prestored criterion information for evaluating blockchain network reliability.

According to an exemplary embodiment, the analysis module 132 may analyze and evaluate information on the blockchain network management company among the information collected by the collection module 131 and quantify the evaluation result.

For example, the analysis module 132 may evaluate the information on the blockchain network management company and give a high value when the reliability is high, or give a low value when the reliability is low.

For example, evaluation criterion values related to a blockchain network management company may be set to 1 to 10, and the analysis module 132 may quantify a reliability evaluation result as one of 1 to 10. Here, the quantification method is not limited thereto.

To this end, the analysis module 132 or the integrated reliability verification server 100 may store criterion information for evaluating the reliability of a blockchain network management company, and the analysis module 132 may comparatively analyze the collected information on the blockchain network management company with the prestored criterion information for evaluating the reliability of a blockchain network management company.

According to an exemplary embodiment, the analysis module 132 may analyze the detailed information on the DApp among the information collected by the collection module 131 and generate a reporting document by documenting corresponding content when it is determined that information requested for use of the DApp may be dangerous.

For example, the analysis module 132 may analyze the detailed information on the DApp and document corresponding content when the DApp requests too many permissions for use of the DApp.

For example, the analysis module 132 may generate a document including the content “The corresponding DApp is an application requesting permissions to do A, B, C, and the like for use of the DApp. The DApp requests too many permissions for use of the DApp and thus may be dangerous to use.”

According to an exemplary embodiment, the analysis module 132 may analyze and evaluate information related to the reliability of the DApp among the information collected by the collection module 131 and quantify the evaluation result.

For example, the analysis module 132 may evaluate the information related to the reliability of the DApp and give a high value when the reliability is high, or give a low value when the reliability is low.

For example, evaluation criterion values related to reliability of a DApp may be set to 1 to 10, and the analysis module 132 may quantify a reliability evaluation result as one of 1 to 10. Here, the quantification method is not limited thereto.

To this end, the analysis module 132 or the integrated reliability verification server 100 may store criterion information for evaluating the reliability of a DApp, and the analysis module 132 may comparatively analyze the collected DApp-related information with the prestored criterion information for evaluating the reliability of a DApp.

According to an exemplary embodiment, the analysis module 132 may analyze and evaluate information on the DApp-related company (including a development company and a management company) among the information collected by the collection module 131 and quantify the evaluation result.

For example, the analysis module 132 may evaluate the information on the DApp-related company and give a high value when the reliability is high, or give a low value when the reliability is low.

For example, evaluation criterion values related to reliability of a DApp-related company may be set to 1 to 10, and the analysis module 132 may quantify a reliability evaluation result as one of 1 to 10. Here, the quantification method is not limited thereto.

To this end, the analysis module 132 or the integrated reliability verification server 100 may store criterion information for evaluating the reliability of a DApp-related company, and the analysis module 132 may comparatively analyze the collected information on the DApp-related company with the prestored criterion information for evaluating the reliability of a DApp-related company.

The verification module 133 according to the exemplary embodiment may verify reliability of the cryptocurrency, the blockchain network, and the DApp on the basis of evaluation results which are output as operation results of the analysis module 132 and stored in the DB 120, that is, values in an exemplary embodiment. Also, the verification module 133 may verify reliability of the cryptocurrency-related company, the blockchain network management company, and the DApp-related company on the basis of the same.

In an exemplary embodiment, the verification module 133 may determine whether a reliability verification target is reliable and give reliability to the reliability verification target. The verification module 133 may store the verification result and the reliability in the DB 120.

For example, the verification module 133 may verify reliability of the reliability verification target by comparing a reliability evaluation result related to the reliability verification target (or a reliability value of the reliability verification target) with a reliability verification criterion value related to the reliability verification target.

According to an exemplary embodiment, the verification module 133 may verify the reliability by comparing one reliability value of the reliability verification target with the reliability verification criterion value.

For example, the verification module 133 may verify the reliability of the reliability verification target at an initial verification point in time or a set certain point in time.

According to an exemplary embodiment, the verification module 133 may perform the reliability by comparing the average of multiple reliability values with the reliability verification criterion value.

For example, reliability values of the reliability verification target may be continuously accumulated in the DB 120, and the verification module 133 may verify the reliability of the reliability verification target on the basis of the average of some or all of the multiple reliability values accumulated in the DB 120.

Accordingly, the verification module 133 can verify the reliability of the reliability verification target for a certain time period desired by a user. Also, the verification module 133 may verify the reliability of the reliability verification target using a latest reliability value as well as past reliability values, and thus accuracy of the verification result can be improved.

According to an exemplary embodiment, the verification module 133 may verify the reliability of the cryptocurrency on the basis of a reliability evaluation result of the cryptocurrency (or a cryptocurrency reliability value).

For example, a criterion value for verifying the reliability of a cryptocurrency may be stored in the verification module 133 or the integrated reliability verification server 100, and the verification module 133 may verify the cryptocurrency by comparing the cryptocurrency reliability value with the criterion value for verifying the reliability of a cryptocurrency.

According to an exemplary embodiment, the verification module 133 may verify the reliability of the cryptocurrency by comparing one cryptocurrency reliability value with the criterion value for verifying the reliability of a cryptocurrency or comparing the average of accumulated cryptocurrency reliability values (the average cryptocurrency reliability value) with the criterion value for verifying the reliability of a cryptocurrency.

The verification module 133 may determine that the cryptocurrency is unreliable when the cryptocurrency reliability value (or the average cryptocurrency reliability value) is less than the criterion value for verifying the reliability of a cryptocurrency, and may determine that the cryptocurrency is reliable when the cryptocurrency reliability value (or the average cryptocurrency reliability value) is the criterion value for verifying the reliability of a cryptocurrency or more.

According to an exemplary embodiment, the verification module 133 may give a degree of reliability on the basis of the cryptocurrency reliability value (or the average cryptocurrency reliability value).

For example, when the cryptocurrency reliability value (or the average cryptocurrency reliability value) is less than the criterion value for verifying the reliability of a cryptocurrency and the cryptocurrency reliability value (or the average cryptocurrency reliability value) is further away from the criterion value for verifying the reliability of a cryptocurrency (i.e., when the cryptocurrency reliability value (or average) is lower), the verification module 133 may give a lower degree of reliability.

Also, when the cryptocurrency reliability value (or the average cryptocurrency reliability value) is the criterion value for verifying the reliability of a cryptocurrency or more and the cryptocurrency reliability value (or the average cryptocurrency reliability value) is further away from the criterion value for verifying the reliability of a cryptocurrency (i.e., when the cryptocurrency reliability value (or average) is higher), the verification module 133 may give a higher degree of reliability.

According to an exemplary embodiment, the verification module 133 may verify the reliability of the cryptocurrency-related company on the basis of a reliability evaluation result of the cryptocurrency-related company (or a reliability value of the cryptocurrency-related company).

For example, a criterion value for verifying the reliability of a cryptocurrency-related company may be stored in the verification module 133 or the integrated reliability verification server 100, and the verification module 133 may verify the cryptocurrency-related company by comparing the reliability value of the cryptocurrency-related company with the criterion value for verifying the reliability of a cryptocurrency-related company.

According to an exemplary embodiment, the verification module 133 may verify the reliability of the cryptocurrency-related company by comparing one reliability value of the cryptocurrency-related company with the criterion value for verifying the reliability of a cryptocurrency-related company or comparing the average of accumulated reliability values of the cryptocurrency-related company (the average reliability value of the cryptocurrency-related company) with the criterion value for verifying the reliability of a cryptocurrency-related company.

The verification module 133 may determine that the cryptocurrency-related company is unreliable when the reliability value of the cryptocurrency-related company (or the average reliability value of the cryptocurrency-related company) is less than the criterion value for verifying the reliability of a cryptocurrency-related company, and may determine that the cryptocurrency-related company is reliable when the reliability value of the cryptocurrency-related company (or the average reliability value of the cryptocurrency-related company) is the criterion value for verifying the reliability of a cryptocurrency-related company or more.

According to an exemplary embodiment, the verification module 133 may give a degree of reliability on the basis of the reliability value of the cryptocurrency-related company (or an average reliability value of the cryptocurrency-related company).

For example, when the reliability value of the cryptocurrency-related company (or the average reliability value of the cryptocurrency-related company) is less than the criterion value for verifying the reliability value of a cryptocurrency-related company and the reliability value of the cryptocurrency-related company (or the average reliability value of the cryptocurrency-related company) is further away from the criterion value for verifying the reliability of a cryptocurrency-related company (i.e., when the reliability value (or average reliability value) of the cryptocurrency-related company is lower), the verification module 133 may give a lower degree of reliability.

Also, when the reliability value of the cryptocurrency-related company (or the average reliability value of the cryptocurrency-related company) is the criterion value for verifying the reliability of a cryptocurrency-related company or more and the reliability value of the cryptocurrency-related company (or the average reliability value of the cryptocurrency-related company) is further away from the criterion value for verifying the reliability of a cryptocurrency-related company (i.e., when the reliability value (or average reliability value) of the cryptocurrency-related company is higher), the verification module 133 may give a higher degree of reliability.

According to an exemplary embodiment, the verification module 133 may verify the reliability of the blockchain network on the basis of a reliability evaluation result of the blockchain network (or a reliability value of the blockchain network).

For example, a criterion value for verifying the reliability of a blockchain network may be stored in the verification module 133 or the integrated reliability verification server 100, and the verification module 133 may verify the blockchain network by comparing the reliability value of the blockchain network with the criterion value for verifying the reliability of a blockchain network.

According to an exemplary embodiment, the verification module 133 may verify the reliability of the blockchain network by comparing one reliability value of the blockchain network with the criterion value for verifying the reliability of a blockchain network or comparing the average of accumulated reliability values of the blockchain network (the average reliability value of the blockchain network) with the criterion value for verifying the reliability of a blockchain network.

The verification module 133 may determine that the blockchain network is unreliable when the reliability value of the blockchain network (or the average reliability value of the blockchain network) is less than the criterion value for verifying the reliability of a blockchain network, and may determine that the blockchain network is reliable when the reliability value of the blockchain network (or the average reliability value of the blockchain network) is the criterion value for verifying the reliability of a blockchain network or more.

According to an exemplary embodiment, the verification module 133 may give a degree of reliability on the basis of the reliability value of the blockchain network (or the average reliability value of the blockchain network).

For example, when the reliability value of the blockchain network (or the average reliability value of the blockchain network) is less than the criterion value for verifying the reliability value of a blockchain network and the reliability value of the blockchain network (or the average reliability value of the blockchain network) is further away from the criterion value for verifying the reliability of a blockchain network (i.e., when the reliability value (or average reliability value) of the blockchain network is lower), the verification module 133 may give a lower degree of reliability.

Also, when the reliability value of the blockchain network (or the average reliability value of the blockchain network) is the criterion value for verifying the reliability of a blockchain network or more and the reliability value of the blockchain network (or the average reliability value of the blockchain network) is further away from the criterion value for verifying the reliability of a blockchain network (i.e., when the reliability value (or average reliability value) of the blockchain network is higher), the verification module 133 may give a higher degree of reliability.

According to an exemplary embodiment, the verification module 133 may verify the reliability of the blockchain network management company on the basis of a reliability evaluation result of the blockchain network management company (or a reliability value of the blockchain network management company).

For example, a criterion value for verifying the reliability of a blockchain network management company may be stored in the verification module 133 or the integrated reliability verification server 100, and the verification module 133 may verify the blockchain network management company by comparing the reliability value of the blockchain network management company with the criterion value for verifying the reliability of a blockchain network management company.

According to an exemplary embodiment, the verification module 133 may verify the reliability of the blockchain network management company by comparing one reliability value of the blockchain network management company with the criterion value for verifying the reliability of a blockchain network management company or comparing the average of accumulated reliability values of the blockchain network management company (the average reliability value of the blockchain network management company) with the criterion value for verifying the reliability of a blockchain network management company.

The verification module 133 may determine that the blockchain network management company is unreliable when the reliability value of the blockchain network management company (or the average reliability value of the blockchain network management company) is less than the criterion value for verifying the reliability of a blockchain network management company, and may determine that the blockchain network management company is reliable when the reliability value of the blockchain network management company (or the average reliability value of the blockchain network management company) is the criterion value for verifying the reliability of a blockchain network management company or more.

According to an exemplary embodiment, the verification module 133 may give a degree of reliability on the basis of the reliability value of the blockchain network management company (or the average reliability value of the blockchain network management company).

For example, when the reliability value of the blockchain network management company (or the average reliability value of the blockchain network management company) is less than the criterion value for verifying the reliability value of a blockchain network management company and the reliability value of the blockchain network management company (or the average reliability value of the blockchain network management company) is further away from the criterion value for verifying the reliability of a blockchain network management company (i.e., when the reliability value (or average reliability value) of the blockchain network management company is lower), the verification module 133 may give a lower degree of reliability.

Also, when the reliability value of the blockchain network management company (or the average reliability value of the blockchain network management company) is the criterion value for verifying the reliability of a blockchain network management company or more and the reliability value of the blockchain network management company (or the average reliability value of the blockchain network management company) is further away from the criterion value for verifying the reliability of a blockchain network management company (i.e., when the reliability value (or average reliability value) of the blockchain network management company is higher), the verification module 133 may give a higher degree of reliability.

According to an exemplary embodiment, the verification module 133 may verify the reliability of the DApp on the basis of a reliability evaluation result of the DApp (or a reliability value of the DApp).

For example, a criterion value for verifying the reliability of a DApp may be stored in the verification module 133 or the integrated reliability verification server 100, and the verification module 133 may verify the DApp by comparing the reliability value of the DApp with the criterion value for verifying the reliability of a DApp.

According to an exemplary embodiment, the verification module 133 may verify the reliability of the DApp by comparing one reliability value of the DApp with the criterion value for verifying the reliability of a DApp or comparing the average of accumulated reliability values of the DApp (the average reliability value of the DApp) with the criterion value for verifying the reliability of a DApp.

The verification module 133 may determine that the DApp is unreliable when the reliability value of the DApp (or the average reliability value of the DApp) is less than the criterion value for verifying the reliability of a DApp, and may determine that the DApp is reliable when the reliability value of the DApp (or the average reliability value of the DApp) is the criterion value for verifying the reliability of a DApp or more.

According to an exemplary embodiment, the verification module 133 may give a degree of reliability on the basis of the reliability value of the DApp (or the average reliability value of the DApp).

For example, when the reliability value of the DApp (or the average reliability value of the DApp) is less than the criterion value for verifying the reliability value of a DApp and the reliability value of the DApp (or the average reliability value of the DApp) is further away from the criterion value for verifying the reliability of a DApp (i.e., when the reliability value (or average reliability value) of the DApp is lower), the verification module 133 may give a lower degree of reliability.

Also, when the reliability value of the DApp (or the average reliability value of the DApp) is the criterion value for verifying the reliability of a DApp or more and the reliability value of the DApp (or the average reliability value of the DApp) is further away from the criterion value for verifying the reliability of a DApp (i.e., when the reliability value (or average reliability value) of the DApp is higher), the verification module 133 may give a higher degree of reliability.

According to an exemplary embodiment, the verification module 133 may verify the reliability of the DApp-related company on the basis of a reliability evaluation result of the DApp-related company (or a reliability value of the DApp-related company).

For example, a criterion value for verifying the reliability of a DApp-related company may be stored in the verification module 133 or the integrated reliability verification server 100, and the verification module 133 may verify the DApp-related company by comparing the reliability value of the DApp-related company with the criterion value for verifying the reliability of a DApp-related company.

According to an exemplary embodiment, the verification module 133 may verify the reliability of the DApp-related company by comparing one reliability value of the DApp-related company with the criterion value for verifying the reliability of a DApp-related company or comparing the average of accumulated reliability values of the DApp-related company (the average reliability value of the DApp-related company) with the criterion value for verifying the reliability of a DApp-related company.

The verification module 133 may determine that the DApp-related company is unreliable when the reliability value of the DApp-related company (or the average reliability value of the DApp-related company) is less than the criterion value for verifying the reliability of a DApp-related company, and may determine that the DApp-related company is reliable when the reliability value of the DApp-related company (or the average reliability value of the DApp-related company) is the criterion value for verifying the reliability of a DApp-related company or more.

According to an exemplary embodiment, the verification module 133 may give a degree of reliability on the basis of the reliability value of the DApp-related company (or the average reliability value of the DApp-related company).

For example, when the reliability value of the DApp-related company (or the average reliability value of the DApp-related company) is less than the criterion value for verifying the reliability value of a DApp-related company and the reliability value of the DApp-related company (or the average reliability value of the DApp-related company) is further away from the criterion value for verifying the reliability of a DApp-related company (i.e., when the reliability value (or average reliability value) of the DApp-related company is lower), the verification module 133 may give a lower degree of reliability.

Also, when the reliability value of the DApp-related company (or the average reliability value of the DApp-related company) is the criterion value for verifying the reliability of a DApp-related company or more and the reliability value of the DApp-related company (or the average reliability value of the DApp-related company) is further away from the criterion value for verifying the reliability of a DApp-related company (i.e., when the reliability value (or average reliability value) of the DApp-related company is higher), the verification module 133 may give a higher degree of reliability.

The notification message transmission module 134 according to the exemplary embodiment may provide a verification result, which is output as an operation result of the verification module 133 and stored in the DB 120, to the interoperating user terminal 700 and provide a degree of reliability together with the verification result.

According to an exemplary embodiment, the notification message transmission module 134 may provide verification results of the cryptocurrency, the blockchain network, and the DApp and also provide verification results of the cryptocurrency-related company, the blockchain network management company, and the DApp-related company.

Also, the notification message transmission module 134 may provide the content of a report document generated by the analysis module 132 to the user terminal 700.

The configuration and component-specific functions and operations of the integrated blockchain-related reliability verification server according to the exemplary embodiment of the present invention have been described above. Operations of the integrated blockchain-related reliability verification server according to the exemplary embodiment of the present invention will be described below.

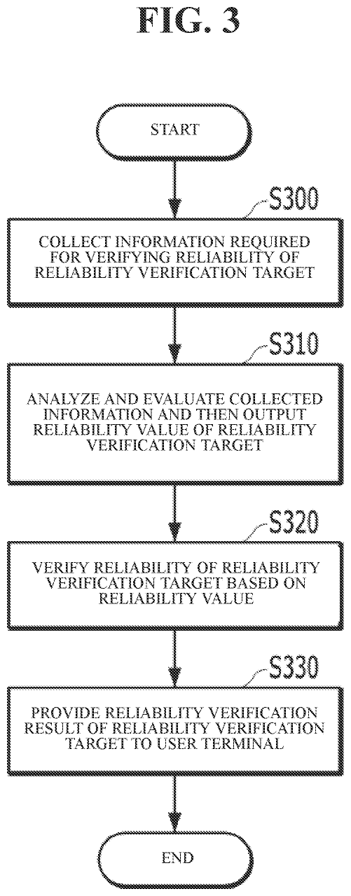

FIG. 3 is a flowchart illustrating operations of an integrated blockchain-based reliability verification server according to an exemplary embodiment of the present invention.

Operations illustrated in FIG. 3 may be performed by the integrated blockchain-related reliability verification server 100 described with reference to FIGS. 1 and 2.

Referring to FIGS. 1 to 3, the collection module 131 of the integrated reliability verification server 100 may collect various types of information required for verifying the reliability of a reliability verification target (S300).

In operation S300, the collection module 131 may collect information required for verifying the reliability of the cryptocurrency, for example, transaction information of the blockchain network 200 and transaction information provided by the exchange server 310.

In operation S300, the collection module 131 may collect information on the cryptocurrency-related company 400 required for verifying the reliability of the cryptocurrency-related company 400. For example, the collection module 131 may collect information in conjunction with the cryptocurrency-related company server 410 or collect information that is made available to the public.

In operation S300, the collection module 131 may collect information required for verifying the reliability of the blockchain network 200, for example, information related to validity of a blockchain network address and information related to whether the blockchain network is actually run.

In operation S300, the collection module 131 may collect information required for verifying the reliability of the blockchain network management company 500. For example, the collection module 131 may collect information in conjunction with a blockchain network management company server 510 or collect information that is made available to the public.

In operation S300, the collection module 131 may collect information required for verifying the reliability of the DApp and the DApp-related company 600.

For example, the collection module 131 may collect detailed information on the DApp and information on the DApp-related company 600. For example, the collection module 131 may collect information in conjunction with the DApp-related company server 610 or collect information that is made available to the public.

Here, the detailed information on the DApp may include information that is requested when the DApp is used.

Information collected in operation S300 may be stored in the DB 120 and used for analysis by the analysis module 132.

After operation S300, the analysis module 132 may analyze and evaluate the information collected in operation S300 and then output reliability values for the reliability verification targets (S310).

In operation S310, the analysis module 132 may analyze and evaluate information collected for verifying the reliability of the cryptocurrency (information related to the reliability of the cryptocurrency) and then output a reliability value of the cryptocurrency.

According to an exemplary embodiment, the analysis module 132 may comparatively analyze collected information related to the reliability of the cryptocurrency-related company with prestored criterion information for evaluating the reliability of a cryptocurrency.

In operation S310, the analysis module 132 may analyze and evaluate information collected for verifying the reliability of the blockchain network (information related to the reliability of the blockchain network) and then output a reliability value of the blockchain network.

According to an exemplary embodiment, the analysis module 132 may comparatively analyze collected information related to the reliability of the blockchain network with prestored criterion information for evaluating the reliability of a blockchain network.

In operation S310, the analysis module 132 may analyze and evaluate information collected for verifying the reliability of the blockchain network management company (information related to the reliability of the blockchain network management company) and then output a reliability value of the blockchain network management company.

According to an exemplary embodiment, the analysis module 132 may comparatively analyze collected information related to the reliability of the blockchain network management company with prestored criterion information for evaluating the reliability of a blockchain network management company.

In operation S310, the analysis module 132 may analyze and evaluate information collected for verifying the reliability of the DApp (information related to the reliability of the DApp) and then output a reliability value of the DApp.

According to an exemplary embodiment, the analysis module 132 may comparatively analyze collected information related to the reliability of the DApp with prestored criterion information for evaluating the reliability of a DApp.

In operation S310, the analysis module 132 may analyze and evaluate information collected for verifying the reliability of the DApp-related company (information related to the reliability of the DApp-related company) and then output a reliability value of the DApp-related company.

According to an exemplary embodiment, the analysis module 132 may comparatively analyze collected information related to the reliability of the DApp-related company with prestored criterion information for evaluating the reliability of a DApp-related company.

In operation S310, the analysis module 132 may analyze detailed information on the DApp. When the DApp in use requests many permissions, the analysis module 132 may generate and output a report document including the corresponding content, and the report document may be stored in the DB 120.

The reliability values of the reliability verification targets which are output in operation S310 may be stored in the DB 120 and used for the verification module 133 to perform verification.

After operation S310, the verification module 133 may verify the reliability of the reliability verification targets on the basis of the reliability values output in operation S310 (S320) and additionally give degrees of reliability to the reliability verification targets.

The reliability verification results and the degrees of reliability of the reliability verification targets may be stored in the DB 120.

In operation S320, the verification module 133 may verify the reliability of the cryptocurrency on the basis of a reliability value (or an average reliability value) of the cryptocurrency.

According to an exemplary embodiment, the verification module 133 may verify the reliability of the cryptocurrency by comparing the reliability value (or the average reliability value) of the cryptocurrency with a prestored criterion value for verifying the reliability of a cryptocurrency.

Verifying the reliability of a cryptocurrency and giving a degree of reliability to a cryptocurrency have been described in detail with reference to FIG. 2 and thus will be omitted here.

In operation S320, the verification module 133 may verify the reliability of the cryptocurrency-related company on the basis of a reliability value (or an average reliability value) of the cryptocurrency-related company.

According to an exemplary embodiment, the verification module 133 may verify the reliability of the cryptocurrency-related company by comparing the reliability value (or the average reliability value) of the cryptocurrency-related company with a prestored criterion value for verifying the reliability of a cryptocurrency-related company.

Verifying the reliability of a cryptocurrency-related company and giving a degree of reliability to a cryptocurrency-related company have been described in detail with reference to FIG. 2 and thus will be omitted here.

In operation S320, the verification module 133 may verify the reliability of the blockchain network on the basis of a reliability value (or an average reliability value) of the blockchain network.

According to an exemplary embodiment, the verification module 133 may verify the reliability of the blockchain network by comparing the reliability value (or the average reliability value) of the blockchain network with a prestored criterion value for verifying the reliability of a blockchain network.

Verifying the reliability of a blockchain network and giving a degree of reliability to a blockchain network have been described in detail with reference to FIG. 2 and thus will be omitted here.

In operation S320, the verification module 133 may verify the reliability of the blockchain network management company on the basis of a reliability value (or an average reliability value) of the blockchain network management company.

According to an exemplary embodiment, the verification module 133 may verify the reliability of the blockchain network management company by comparing the reliability value (or the average reliability value) of the blockchain network management company with a prestored criterion value for verifying the reliability of a blockchain network management company.

Verifying the reliability of a blockchain network management company and giving a degree of reliability to a blockchain network management company have been described in detail with reference to FIG. 2 and thus will be omitted here.

In operation S320, the verification module 133 may verify the reliability of the DApp on the basis of a reliability value (or an average reliability value) of the DApp.

According to an exemplary embodiment, the verification module 133 may verify the reliability of the DApp by comparing the reliability value (or the average reliability value) of the DApp with a prestored criterion value for verifying the reliability of a DApp.

Verifying the reliability of a DApp and giving a degree of reliability to a DApp have been described in detail with reference to FIG. 2 and thus will be omitted here.

In operation S320, the verification module 133 may verify the reliability of the DApp-related company on the basis of a reliability value (or an average reliability value) of the DApp-related company.

According to an exemplary embodiment, the verification module 133 may verify the reliability of the DApp-related company by comparing the reliability value (or the average reliability value) of the DApp-related company with a prestored criterion value for verifying the reliability of a DApp-related company.

Verifying the reliability of a DApp-related company and giving a degree of reliability to a DApp-related company have been described in detail with reference to FIG. 2 and thus will be omitted here.

After operation S320, the notification message transmission module 134 may provide reliability verification results of the reliability verification targets to the interoperating user terminal 700 (S330) and additionally provide the degrees of reliability.

In operation S330, the notification message transmission module 134 may provide the reliability verification results of the cryptocurrency, the blockchain network, the DApp, the cryptocurrency-related company, the blockchain network management company, and the DApp-related company and additionally provide the degrees of reliability of the reliability verification targets.

Also, the notification message transmission module 134 may provide content included in the report document generated by the analysis module 132 to the user terminal 700.

Combinations of blocks of a block diagram and operations of a flowchart appended to the specification may be performed by computer program instructions. These computer program instructions may be installed in a processor of a general-purpose computer, a special-purpose computer, or other programmable data processing equipment, and thus the instructions executed by the processor of the computer or the other programmable data processing equipment generate elements for performing functions described in the blocks of the block diagram or the operations of the flowchart.

According to embodiments disclosed in the specification, it is possible to provide an integrated blockchain-related reliability verification server for verifying reliability of dangerous elements that may exist when a blockchain is used.

According to embodiments, it is possible to provide an integrated blockchain-related reliability verification server for not only verifying reliability (or safety) of a cryptocurrency (or a token) by monitoring (collecting and analyzing) information related to reliability of the cryptocurrency among transaction information provided by a network or exchange related to the cryptocurrency but also verifying the reliability by collecting information on an individual or group that develops or runs the cryptocurrency.

According to embodiments, it is possible to provide an integrated blockchain-related reliability verification server for verifying reliability in relation to a blockchain network related to a cryptocurrency by monitoring information related to validity of a network address, whether the network is actually run, and a network management community.

According to embodiments, it is possible to provide an integrated blockchain-related reliability verification server for verifying reliability of a DApp, which is a blockchain-based application, by giving a notification of a request that may be dangerous (e.g., a request for too many permissions) among requests that may be made by the DApp and monitoring information related to the reliability of the DApp and information on an individual or group that develops or manages the DApp.

Such an integrated blockchain-related reliability verification server according to an embodiment of the present invention verifies reliability of a virtual currency, a blockchain network, and a DApp, and thus a user can safely use a service such as a blockchain-based cryptocurrency transaction and the like.

Effects of the present invention are not limited to those described above, and other effects which have not been described above may also be clearly understood by those skilled in the art from the following description.

The foregoing objectives, solutions, and effects do not specify essential features of claims, and the scope of the claims is not limited thereto.

Although exemplary embodiments of the present invention have been described above in detail with reference to the accompanying drawings, the present invention is not necessarily limited thereto and may be implemented as various modifications without departing from the technical scope of the present invention. Accordingly, the embodiments disclosed herein are intended not to limit but to describe the technical scope of the present invention, and the technical scope of the present invention is not limited to the embodiments. Therefore, the exemplary embodiments described above should be understood as illustrative rather than limiting in all aspects. The scope of the present invention should be interpreted on the basis of the claims, and all technical spirits within a scope equivalent thereto should be construed as falling within the scope of the present invention.

What is claimed is:

1. A server for verifying reliability of a target that is a potentially dangerous element when a blockchain is used, the server comprising a processor configured to verify reliability of at least one of a cryptocurrency, a blockchain network, and a decentralized application (DApp),
wherein the processor comprises:
a collection module configured to collect information required for verifying reliability of the cryptocurrency, the blockchain network, and the DApp;
an analysis module configured to analyze and evaluate the collected information and then output a reliability value of a reliability verification target as an evaluation result; and
a verification module configured to verify reliability of the reliability verification target on the basis of the reliability value.

2. The server of claim 1, wherein the processor further verifies reliability of at least one of a cryptocurrency-related company, a blockchain network management company, and a DApp-related company.

3. The server of claim 1, wherein the processor further comprises a notification message transmission module configured to provide a verification result of the reliability verification target to an interoperating user terminal.

4. The server of claim 1, wherein the collection module collects information related to the reliability of the cryptocurrency among transaction information of the blockchain network and collects information related to the reliability of the cryptocurrency among transaction information provided by a cryptocurrency exchange.

5. The server of claim 1, wherein the collection module collects information related to validity of a blockchain network address and information related to whether the blockchain network is actually run.

6. The server of claim 1, wherein the collection module collects detailed information on the DApp, and
the detailed information includes information requested for use of the DApp by the DApp.

7. The server of claim 6, wherein the analysis module analyzes the detailed information and generates a report document including corresponding content when the DApp in use requests many permissions.

8. The server of claim 7, wherein the processor further comprises a notification message transmission module configured to provide a verification result of the reliability verification target and content included in the report document to an interoperating user terminal.

9. The server of claim 1, wherein the analysis module comparatively analyzes information collected for verifying the reliability of the reliability verification target with reliability evaluation criterion information prestored in relation to the reliability verification target.

10. The server of claim 1, wherein the verification module verifies the reliability of the reliability verification target by comparing a reliability verification criterion value prestored in relation to the reliability verification target with the reliability value.

11. The server of claim 10, wherein the verification module compares one reliability value related to the reliability verification target or an average of accumulated reliability values with the reliability verification criterion value.

12. An integrated blockchain-related reliability verification platform comprising:
a blockchain network;
a cryptocurrency exchange server;
a decentralized application (DApp)-related company server; and
an integrated reliability verification server configured to interoperate with the blockchain network, the cryptocurrency exchange server, and the DApp-related company server,
wherein the integrated reliability verification server is the server of claim 1.

13. The integrated blockchain-related reliability verification platform of claim 12, further comprising a cryptocurrency-related company server and a blockchain network management company server which interoperate with the integrated reliability verification server.

14. An operating method of a server for verifying reliability of a target that is a potentially dangerous element when a blockchain is used, the operating method comprising:
collecting information required for verifying reliability of a cryptocurrency, a blockchain network, and a decentralized application (DApp);
analyzing and evaluating the collected information and then outputting a reliability value of a reliability verification target as an evaluation result; and
verifying reliability of the reliability verification target on the basis of the reliability value.

15. The operating method of claim 14, further comprising verifying reliability of at least one of a cryptocurrency-related company, a blockchain network management company, and a DApp-related company.

16. The operating method of claim 14, further comprising providing a verification result of the reliability verification target to an interoperating user terminal.

17. The operating method of claim 14, wherein the collecting of the information comprises collecting information related to the reliability of the cryptocurrency among transaction information of the blockchain network and collecting information related to the reliability of the cryptocurrency among transaction information provided by a cryptocurrency exchange.

18. The operating method of claim 14, wherein the collecting of the information comprises collecting information related to validity of a blockchain network address and information related to whether the blockchain network is actually run.

19. The operating method of claim 14, wherein the collecting of the information comprises collecting detailed information on the DApp, and
the detailed information includes information requested for use of the DApp by the DApp.

20. The operating method of claim 19, wherein the analyzing of the collected information comprises analyzing the detailed information and generating a report document including corresponding content when the DApp in use requests many permissions.

21. The operating method of claim 20, further comprising providing a verification result of the reliability verification target and content included in the report document to an interoperating user terminal.

22. The operating method of claim 14, wherein the analyzing of the collected information comprises comparatively analyzing information collected for verifying reliability of the reliability verification target with reliability evaluation criterion information prestored in relation to the reliability verification target.

23. The operating method of claim 14, wherein the verifying of the reliability comprises verifying reliability of the reliability verification target by comparing the reliability value with a reliability verification criterion value prestored in relation to the reliability verification target.

24. The operating method of claim 23, wherein the verifying of the reliability comprises comparing one reliability value related to the reliability verification target or an average of accumulated reliability values with the reliability verification criterion value.
